(19) United States
(12) Patent Application Publication
(10) Pub. No.: US 2019/0392957 A1
(43) Pub. Date: Dec. 26, 2019

(54) Core of Fast Reactor

(71) Applicant: Hitachi-GE Nuclear Energy, Ltd., Hitachi-shi (JP)

(72) Inventors: Koji FUJIMURA, Tokyo (JP); Junichi MIWA, Tokyo (JP)

(21) Appl. No.: 16/447,073

(22) Filed: Jun. 20, 2019

(30) Foreign Application Priority Data
Jun. 26, 2018 (JP) 2018-120445

(51) Int. Cl. G21C 3/326; G21C 1/02; G21C 3/60; G21C 5/20; G21C 7/08; G21C 11/06

(52) U.S. Cl. CPC G21C 3/3267; G21C 1/024; G21C 3/3265; G21C 11/06; G21C 5/20; G21C 7/08; G21C 3/60

(57) ABSTRACT

There is provided a core of a fast reactor including: a core fuel region in which core fuel assemblies loading a metal fuel are arranged on a central region in a radial direction of the core; an inner blanket fuel region in which blanket fuel assemblies loading another metal fuel are circumferentially arranged on an inner portion of the core fuel region; and an outer peripheral blanket fuel region in which the blanket fuel assemblies are circumferentially arranged on an outer periphery of the core fuel region, wherein the metal fuel is formed of a U—Pu—Zr alloy or an alloy of U, Pu, TRU other than Pu, and Zr, the other metal fuel is formed of an alloy of U and Zr, and the Zr content of the other metal fuel is lower than the Zr content of the metal fuel.

### CLAIM OF PRIORITY

The present application claims priority from Japanese patent application serial no. 2018-120445 filed on Jun. 26, 2018, the content of which is hereby incorporated by reference into this application.

### TECHNICAL FIELD OF THE INVENTION

The present invention relates to a core of a fast reactor that uses a metal fuel, and in particular, to a core having a configuration that contributes to an improvement of a breeding capability.

### DESCRIPTION OF RELATED ART

The fast reactor refers to a nuclear reactor that uses nuclear fission by fast neutrons, and a fast reactor that produces plutonium 239 (Pu-239) from uranium 238 (U-238) fuel by a chain reaction of the nuclear fission is often referred to as a fast breeder reactor.

The core of a fast reactor usually has a core fuel assembly at the center in a radial direction, a blanket fuel assembly that plays a role of breeding is arranged on an outer periphery of the core fuel assembly, and a neutron reflector that plays a role of neutron shielding is arranged on the outermost periphery. The core fuel assembly is often divided into two regions which are an inner core region and an outer core region, in order to flatten a power distribution.

In the related art, as a fuel of a fast reactor, a mixed oxide (MOX) fuel has been mainly used. However, in recent years, the use of metal fuel has been reviewed from viewpoints of heat transfer characteristics and economic efficiency, and research and development are being conducted.

For example, PTL 1 (JP-A-2005-83966) discloses a two-region fast reactor that uses a metal fuel and is divided into an inner core region and an outer core region in order to flatten a power distribution, in which a ternary alloy formed of U, Pu or a transuranium element (TRU) mainly including Pu, and Zr (zirconium) is used as the metal fuel, all fuel pins have a single degree of Pu enrichment of the fuel and the same pin diameters as each other, and an inner core fuel pin is set to have a larger value in the Zr content of metal fuel slag than that of an outer core fuel pin.

In addition, PTL 2 (JP-A-2006-226905) discloses a metal fuel fast reactor core that uses a metal fuel formed of heavy metals including U and Pu or TRU mainly including Pu, and an alloy metal with the heavy metal, and is divided into multiple core regions in a radial direction of the core, in which all fuel pins have the same degree of Pu enrichment and the same pin diameter, the multiple core regions respectively having different heavy metal densities are secured in the radial direction of the core, and the region division is performed by changing the alloy metal content and a fuel smear density.

### CITATION LIST

### Patent Literature

PTL 1: JP-A-2005-83966; and

PTL 2: JP-A-2006-226905.

### SUMMARY OF THE INVENTION

### Problems to be Solved by the Invention

In the core design of the fast reactor, a core fuel composition, a fuel concentration, and a core external size (a radial directional size and an axial directional size of the core) are approximately determined basically according to the size of electrical output, and based on the above, a fuel assembly design is performed, and thereafter, a calorific value design and a cooling heat transport design are performed.

In order to increase a breeding ratio, which is the primary purpose of the fast reactor, an increase of the fuel inventory (in particular, blanket fuel inventory) is effective. However, when trying to simply increase the blanket fuel inventory, almost all items including the core fuel composition and the core external size are required to be redesigned, which causes a cost increase. In particular, since an increase in the core external size leads to an increase in the size of a reactor vessel accommodating the core and cooling system equipment, a problem of a significant cost increase occurs.

On the other hand, in order to commercialize a fast reactor, technology development for cost reduction is one of the most important objects.

Therefore, an objective of the invention is to provide a core capable of improving a breeding ratio more than the core of the related art when compared with the core having the same external size, in a metal fuel fast reactor.

### Solution to Problems

According to an aspect of the invention, a core of a fast reactor includes:

a core fuel region in which core fuel assemblies loading metal fuel are arranged on a central region in a radial direction of the core;

an inner blanket fuel region in which blanket fuel assemblies loading other metal fuel are circumferentially arranged on an inner portion of the core fuel region; and

an outer peripheral blanket fuel region in which the blanket fuel assemblies are circumferentially arranged on an outer periphery of the core fuel region, in which

the metal fuel is formed of a U—Pu—Zr alloy or an alloy of U, Pu, a transuranium element (TRU) other than Pu, and Zr,

the other metal fuel is formed of an alloy of U and Zr, and

the Zr content of the other metal fuel is lower than the Zr content of the metal fuel.

In the invention, it is possible to add the following improvements and changes to the core of a fast reactor according to the invention described above.

(i) The inner blanket fuel region is configured to include a first inner blanket fuel region circumferentially arranged on the inner side in the radial direction of the core and a second inner blanket fuel region circumferentially arranged on the outer side in the radial direction of the core.

(ii) The Zr content of the metal fuel is 10% by mass, and the Zr content of the other metal fuel is 6% by mass.

(iii) The core further includes control rod assemblies loading a neutron absorption material, and the control rod assemblies are arranged on the inner portion of the core fuel region and are not arranged on the periphery of the inner blanket fuel region.

(iv) The diameter of a fuel element constituting the blanket fuel assembly is larger than the diameter of a fuel element constituting the core fuel assembly.

(v) The diameter of each fuel element constituting the blanket fuel assembly in the outer peripheral blanket fuel region is larger than the diameter of each fuel element constituting the blanket fuel assembly in the inner blanket fuel region.

(vi) In the core fuel assembly, an upper axial blanket fuel including the other metal fuel is further loaded vertically above the loaded metal fuel in a core axial direction and a lower axial blanket fuel including the other metal fuel is further loaded vertically below the loaded metal fuel in the core axial direction.

(vii) The length of the other metal fuel loaded in the fuel element constituting the blanket fuel assembly in the core axial direction is shorter than the total length of the metal fuel loaded in the fuel element constituting the core fuel assembly and the lower axial blanket fuel in the core axial direction.

(viii) The core further includes: an axially upper shielding region in which neutron shieldings are arranged vertically above the core fuel region, the inner blanket fuel region, and the outer peripheral blanket fuel region in the core axial direction in a sealed manner;

an axially lower shielding region in which the neutron shieldings are arranged vertically below the core fuel region, the inner blanket fuel region, and the outer peripheral blanket fuel region in the core axial direction in a sealed manner; and a radially shielding region in which the neutron shieldings are circumferentially arranged on an outer periphery of the outer peripheral blanket fuel region in the radial direction of the core.

### Advantages of the Invention

According to the invention, in a high-output metal fuel fast reactor (for example, a metal fuel fast reactor with an electrical output of 300,000 kW or more), it is possible to prevent a breeding ratio from deteriorating, without changing the external size of the core. In other words, it is possible to provide a core in which a breeding ratio is improved more than a core of the related art when compared with the core having the same external size. Also, in the core design to achieve a desired electrical output, since the knowledge of the related art can be utilized when designing the external size of the core, it is possible to reduce additional costs required for designing a new core.

### BRIEF DESCRIPTION OF DRAWINGS

FIG. 1 is a horizontal cross-sectional schematic diagram (½ region) illustrating an example of a core of a fast reactor according to the invention.

FIG. 2 is a vertical cross-sectional schematic diagram illustrating an example of a core fuel assembly and a horizontal cross-sectional schematic diagram of an A-A position.

FIG. 3 is a vertical cross-sectional schematic diagram illustrating an example of a blanket fuel assembly and a horizontal cross-sectional schematic diagram of a B-B position.

FIG. 4 is a vertical cross-sectional schematic diagram (½ region) illustrating an example of the core of a fast reactor according to the invention.

FIG. 5 is a vertical sectional schematic diagram (½ region) illustrating an example of the core according to a third embodiment.

### DETAILED DESCRIPTION OF PREFERRED EMBODIMENTS

### Basic Idea of the Invention

As described above, when trying to simply increase a diameter of a blanket fuel element or increase the number of blanket fuel assemblies in order to increase the breeding ratio, almost all items including a core fuel composition and a core external size are required to be redesigned, which causes a cost increase. In particular, since an increase in the core external size leads to an increase in the size of a reactor vessel accommodating the core and cooling system equipment, a possibility of a significant cost increase is high.

Therefore, the present inventors intensively studied on a core configuration capable of increasing the breeding ratio without changing the core external size which is basically designed according to the electric output. As a result, a possibility of solution was found in that a blanket fuel region (referred to as an inner blanket fuel region) including blanket fuel assemblies is circumferentially arranged in a core fuel region (a region in which core fuel assemblies are collectively arranged) in addition to the core structure of the related art and the Zr content in a blanket fuel is set to be smaller than the Zr content in a core fuel. The invention has been completed based on the findings.

Hereinafter, embodiments of the invention will be specifically described with reference to the drawings. Also, the invention is not limited to the embodiments stated here, and can be appropriately combined with the known techniques or improved based on the known techniques without departing from the technical idea of the invention. The same reference signs may be attached to synonymous components, and overlapping descriptions may be omitted.

### First Embodiment

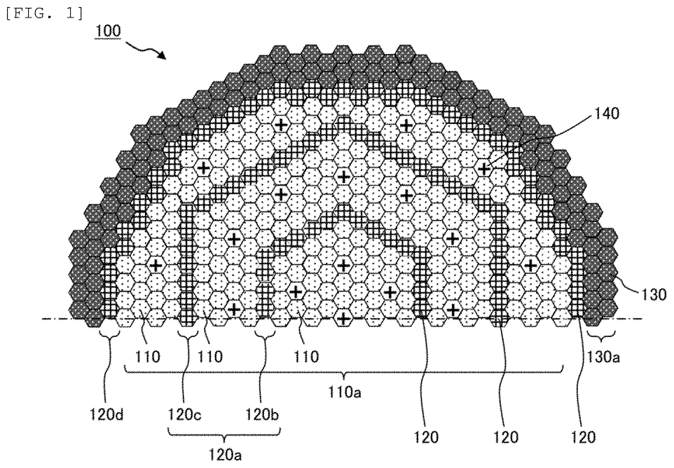

FIG. 1 is a horizontal cross-sectional schematic diagram (½ region) illustrating an example of a core of a fast reactor according to the invention. As illustrated in FIG. 1, a core 100 of a fast reactor according to the invention includes a core fuel region 110a in which core fuel assemblies 110 loading a metal fuel are collectively arranged on a central region in a radial direction of the core, an inner blanket fuel region 120a in which blanket fuel assemblies 120 loading another metal fuel are circumferentially arranged on an inner portion of the core fuel region 110a, an outer peripheral blanket fuel region 120d in which the blanket fuel assemblies 120 are circumferentially arranged on an outer periphery of the core fuel region 110a, and a radial shielding region 130a in which the neutron shieldings 130 are circumferentially arranged on an outer periphery of the outer peripheral blanket fuel region 120d.

FIG. 1 illustrates an example in which the inner blanket fuel region 120a includes two regions of a first inner blanket fuel region 120b circumferentially arranged on an inner side in the radial direction of the core and a second inner blanket fuel region 120c circumferentially arranged on an outer side in the radial direction of the core. The invention is not limited to the inner blanket fuel region 120a including two regions (the inner blanket fuel region 120a may include only one region), but since a core diameter (in particular, a diameter of the core fuel region) tends to expand in a core for high output, the inner blanket fuel region 120a is more preferably configured to include two or more regions according to the designed output.

Also, the core 100 further includes control rod assemblies 140 loading a neutron absorption material as in the related art in order to perform output control. However, from the viewpoint of securing required control reactivity, the control rod assemblies 140 are preferably arranged on the inner portion of the core fuel region 110a so as to replace core fuel assemblies 110 and are not arranged on the periphery of the inner blanket fuel region 120a (within the region of the inner blanket fuel region 120a).

Next, the core fuel assembly 110 and the blanket fuel assembly 120 will be described.

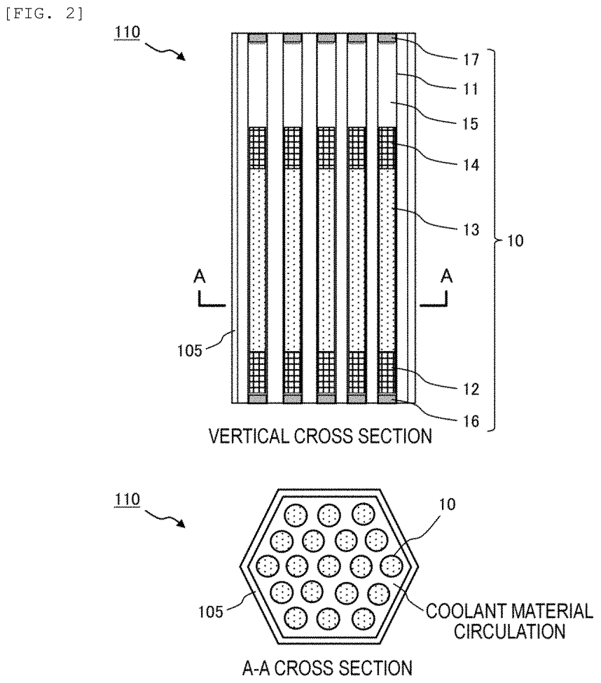

FIG. 2 is a vertical cross-sectional schematic diagram illustrating an example of a core fuel assembly and a horizontal cross-sectional schematic diagram of an A-A position. In FIG. 2, a vertical direction of the vertical cross-sectional schematic diagram is the core axial direction, an upper direction represents a vertically upper direction, and a lower direction represents a vertically lower direction. As illustrated in FIG. 2, in the core fuel assembly 110, a plurality (for example, approximately 170 to 330) of fuel elements 10 (also referred to as fuel pins or fuel rods) are contained in a wrapper tube 105, and a coolant material (for example, liquid metal sodium) is circulated through a space between each fuel element 10 and the wrapper tube 105.

In the fuel element 10, a lower axial blanket fuel 12, a core fuel 13, an upper axial blanket fuel 14, and an upper gas plenum 15 are loaded in a cladding 11 (for example, having an outer diameter of approximately 6 to 9 mm) formed of ferritic stainless steel, and both ends of the cladding 11 are respectively sealed with a lower end plug 16 and an upper end plug 17. Also, the space between fuels (the lower axial blanket fuel 12, the core fuel 13, and the upper axial blanket fuel 14) and the cladding 11 is filled with a bond material (for example, metallic sodium) (not illustrated).

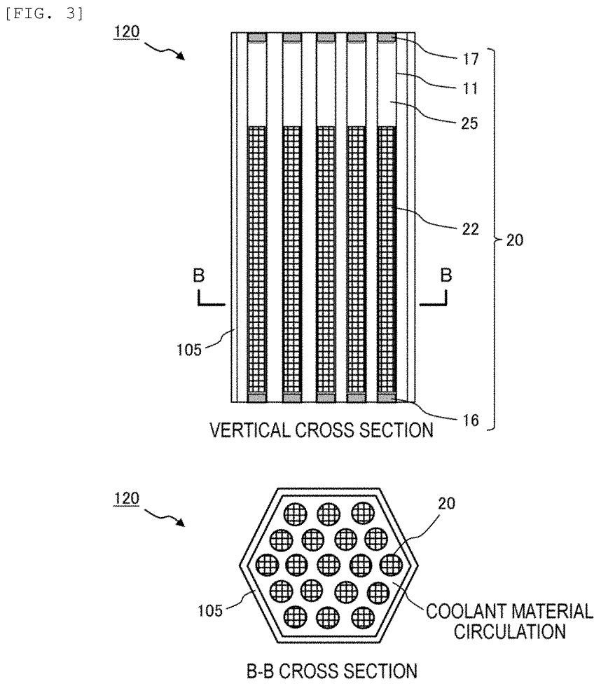

FIG. 3 is a vertical cross-sectional schematic diagram illustrating an example of a blanket fuel assembly and a horizontal cross-sectional schematic diagram of a B-B position. In FIG. 3, as in FIG. 2, a vertical direction of the vertical cross-sectional schematic diagram is the core axial direction, an upper direction represents a vertically upper direction, and a lower direction represents a vertically lower direction. As illustrated in FIG. 3, in the blanket fuel assembly 120, a plurality (for example, approximately 90 to 330) of fuel elements 20 are contained in the wrapper tube 105, and a coolant material (for example, liquid metal sodium) is circulated through a space between each fuel element 20 and the wrapper tube 105.

The fuel element 20 is loaded with a blanket fuel 22 and an upper gas plenum 25 and both ends of the cladding 11 are respectively sealed with the lower end plug 16 and the upper end plug 17. Also, the space between the blanket fuel 22 and the cladding 11 is filled with a bond material (for example, metallic sodium) (not illustrated).

As in the related art, for the core fuel 13, it is preferable to use a metal fuel including an alloy of U, Pu, and Zr (U—Pu—Zr alloy), or an alloy of U, TRU, and Zr (U-TRU—Zr alloy) and having a Zr content of 10% by mass. On the other hand, for the lower axial blanket fuel 12, the upper axial blanket fuel 14, and the blanket fuel 22, it is preferable to use a metal fuel including an alloy of U and Zr (U—Zr alloy) and having a Zr content lower than the Zr content of the core fuel 13, and it is more preferable to use a metal fuel having Zr of 6% by mass.

The present inventors have found that the blanket fuel assembly has a calorific value lower than that of the core fuel assembly and has an excellent tolerance for a melting point of the metal fuel, by detailed calorific value analysis on the fuel assembly. Therefore, the invention has reached a technical idea that the breeding ratio can be improved by controlling the Zr content of the metal fuel used as a blanket fuel to be low (that is, by increasing the U content).

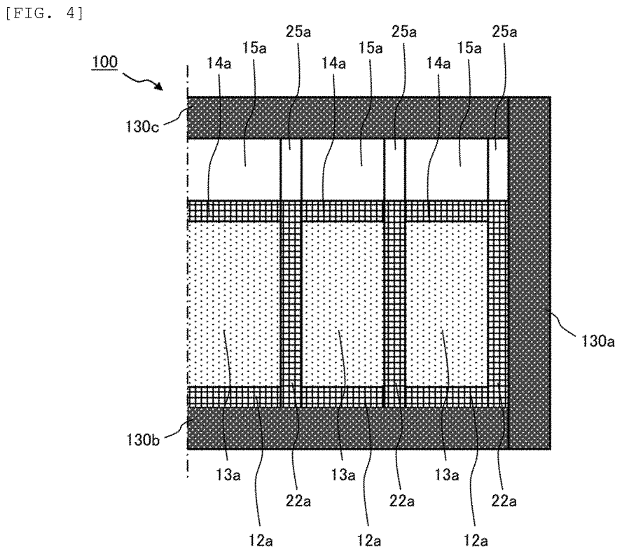

FIG. 4 is a vertical cross-sectional schematic diagram (½ region) illustrating an example of the core of a fast reactor according to the invention. In FIG. 4, the illustration of the cladding and the wrapper tube is omitted from the viewpoint of drawing simplification, and only the regions are illustrated.

As illustrated in FIG. 4, the core 100 includes a core fuel region 13a (corresponding to the core fuel region 110a in FIG. 1) on a central region in a radial direction of the core (a left-right direction in the drawing), a two layers of blanket fuel regions 22a (respectively corresponding to the first inner blanket fuel region 120b and the second inner blanket fuel region 120c in FIG. 1) arranged on an inner portion of the core fuel region 13a, a blanket fuel region 22a (corresponding to the outer peripheral blanket fuel region 120d in FIG. 1) arranged on an outer periphery of the core fuel region 13a, and a radial shielding region 130a arranged on the outer circumference thereof.

Also, in the core axial direction (vertical direction in the drawing), the core fuel region 13a is arranged on the central region, the lower axial blanket fuel region 12a (a region including the lower axial blanket fuel 12) is arranged axially below the core fuel region 13a, the upper axial blanket fuel region 14a (a region including the upper axial blanket fuel 14) is arranged axially above the core fuel region 13a, and an upper gas plenum region 15a (a region including the upper gas plenum 15) is arranged axially above the upper axial blanket fuel region 14a.

Also, an upper gas plenum region 25a (a region including the upper gas plenum 25) is also arranged axially above blanket fuel regions 22a (respectively corresponding to the first inner blanket fuel region 120b, the second inner blanket fuel region 120c, and the outer peripheral blanket fuel region 120d in FIG. 1).

Further, an axially lower shielding region 130b including the neutron shieldings is arranged axially below the lower axial blanket fuel region 12a and the blanket fuel region 22a, and an axially upper shielding region 130c including the neutron shieldings is arranged axially upper the upper gas plenum regions 15a and 25a.

As can be seen from FIG. 4, the core 100 of the first embodiment is configured such that an upper surface of the upper axial blanket fuel region 14a and an upper surface of the blanket fuel region 22a are aligned. In other words, the configuration is made such that the total height (total axial length) of the lower axial blanket fuel region 12a, the core fuel region 13a, and the upper axial blanket fuel region 14a is the same as the height (axial length) of the blanket fuel region 22a.

The present inventors conducted simulation comparison of output characteristics between the core 100 of the first embodiment in which a U-Pu-10 mass % Zr alloy is used as the core fuel 13 and a U-6 mass % Zr alloy is used as the blanket fuel 22, and a core (comparative example) having the same configuration except that a U-10 mass % Zr alloy is used as the blanket fuel 22.

Core design conditions were as follows. The outer diameter of the cladding 11 of the fuel element 10 in FIG. 2 and the fuel element 20 in FIG. 3 was set to be 9 mm. The numbers of the core fuel assemblies 110 in FIG. 2 and the blanket fuel assemblies 120 in FIG. 3 loaded into the wrapper tube 105 were respectively set to be 169. The pitch of the core fuel assembly 110 and the blanket fuel assembly 120 was set to be 16 cm. The height (axial length) of the core fuel 13 was set to be 66 cm, and the height of the blanket fuel 22 was set to be 107 cm. In addition, the electric output of the core was set to be 300,000 kWe. The continuous operation period was set to be 23 months. The batch number of refueling of the core fuel assemblies was set to be 3. The batch number of refueling of the blanket assemblies was set to be 5. The average discharge burnup of the core fuel was set to 100 GWd/t.

As a result, the breeding ratio in the core of the comparative example was approximately 1.06, whereas the breeding ratio of the core 100 of the first embodiment was improved to approximately 1.20. That is, it was confirmed that the core according to the invention can improve the breeding ratio when compared with the core having the same external size.

### Second Embodiment

A second embodiment is different from the first embodiment in the configuration of the blanket fuel assembly, and the others are the same. Accordingly, only the configuration of the blanket fuel assembly in the second embodiment will be described.

In the second embodiment, the cladding of the fuel element of the blanket fuel assembly is made larger in diameter than that of the core fuel assembly. For example, when the outer diameter of the cladding 11 of the fuel element 20 of the blanket fuel assembly 120 is increased from 9 mm to 11 mm and the loading number into the wrapper tube 105 is set to be 127, the blanket fuel 22 can be loaded by about 12% more than the blanket fuel assembly 120 of the first embodiment (outer diameter of the cladding of 9 mm and loading number into the wrapper tube 105 of 169).

The simulation of the output characteristics was conducted under the same core design conditions as the first embodiment, except that the configuration of the blanket fuel assembly in the outer peripheral blanket fuel region was changed as described above. As a result, the breeding ratio of the core of the first embodiment was approximately 1.20, whereas the breeding ratio of the core of the second embodiment was improved to approximately 1.25. That is, it was confirmed that the core of the second embodiment can further improve the breeding ratio more than the core of the first embodiment.

In the above simulation example, only the blanket fuel assembly of the outer peripheral blanket fuel region is set to the blanket fuel assembly of the present embodiment, but the invention is not limited thereto. For example, when it is determined that a degree of thermal margin can be secured even in the blanket fuel assembly of the inner blanket fuel region from a calorific value analysis of each fuel assembly, the blanket fuel assembly of the present embodiment may also be used in the inner blanket fuel region.

### Third Embodiment

A third embodiment is different from the first and second embodiments in the configuration of the blanket fuel assembly, and the others are the same. Accordingly, only the configuration of the blanket fuel assembly in the third embodiment will be described.

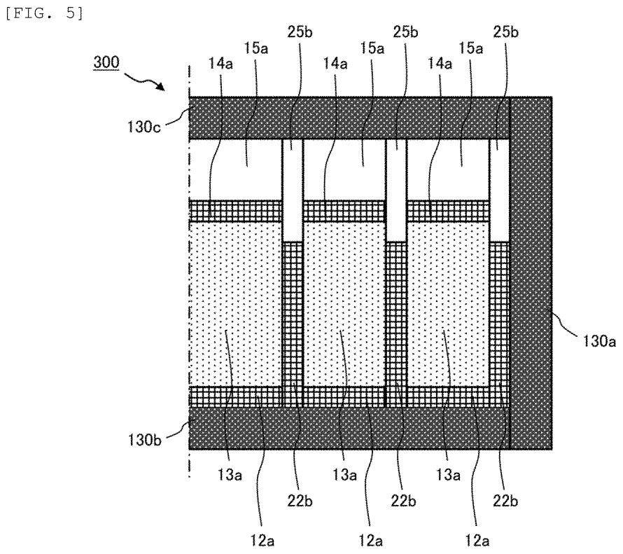

FIG. 5 is a vertical cross-sectional schematic diagram (½ region) illustrating an example of a core of a fast reactor according to the third embodiment. In FIG. 5, as in FIG. 4, an illustration of the cladding and the wrapper tube is omitted from the viewpoint of drawing simplification, and only the regions are illustrated.

As illustrated in FIG. 5, in a core 300, a height (axial length) of the blanket fuel region 22b of the blanket fuel assembly is shorter than the total height (axial total length) of the lower axial blanket fuel region 12a, the core fuel region 13a, and the upper axial blanket fuel region 14a of the core fuel assembly in the core axial direction when compared with the core 100 (first embodiment) of FIG. 4. In other words, the axial length of the upper gas plenum region 25b of the blanket fuel assembly is longer than the axial length of the upper gas plenum region 15a of the core fuel assembly.

Most of the fast neutrons generated in the nuclear fission reaction are generated in the core fuel region 13a of the core fuel assembly, but a part of the core fuel region 13a is adjacent to the upper gas plenum region 25b of the blanket fuel assembly. Therefore, a leakage amount of fast neutrons in the radial direction of the core increases. Such a configuration has an operational effect of further enhancing safety even in a situation of an unprotected loss of flow (ULOF) with scrum failure because the void reactivity becomes a value in the more negative side.

On the other hand, from the viewpoint of the breeding ratio, it is disadvantageous that the effective length of the blanket fuel region 22b of the blanket fuel assembly is shortened. Therefore, the degree of shortening the height of the blanket fuel region 22b is preferably equal to or less than the amount by which the blanket fuel 22 is increased compared to the first embodiment according to the second embodiment.

For example, in the example of the second embodiment, since the blanket fuel 22 is increased by about 12% compared to the first embodiment, the height of the blanket fuel region 22b is preferably set to be shortened by a range of 12% or less compared to the example of the second embodiment, as an example of the third embodiment. As a result, it is possible to improve security over the first embodiment while achieving a breeding ratio (1.20 or more) equal to or higher than that of the first embodiment.

The embodiment described above is described to help to understand the invention, and the invention is not limited to only the described specific configuration. For example, a part of the configuration of the embodiments can be replaced with a configuration of common sense of those skilled in the art and the configuration of common sense of those skilled in the art can be also added to the configuration of the embodiments. That is, for the invention, deletion, replacement with another configuration, and addition of another configuration can be made on a part of the configurations of the embodiments of the present specification, within the range not departing from the technical idea of the invention.

### LEGEND

100, 300: Core;
105: Wrapper tube;
110: Core fuel assembly;
110a: Core fuel region;
120: Blanket fuel assembly;
120a: Inner blanket fuel region;
120b: First inner blanket fuel region;
120c: Second inner blanket fuel region;
120d: Outer peripheral blanket fuel region;
130: Neutron shielding;
130a: Radial shielding region;
130b: Axially lower shielding region;
130c: Axially upper shielding region;
10: Fuel element;
11: Cladding;
12: Lower axial blanket fuel;
12a: Lower axial blanket fuel region;
13: Core fuel;
13a: Core fuel region;
14: Upper axial blanket fuel;
14a: Upper axial blanket fuel region;
15: Upper gas plenum;
15a: Upper gas plenum region;
16: Lower end plug;
17: Upper end plug;
20: Fuel element;
22: Blanket fuel;
22a: Blanket fuel region;
25: Upper gas plenum; and
25a: Upper gas plenum region.

1. A core of a fast reactor, comprising:
a core fuel region in which core fuel assemblies loading a metal fuel are collectively arranged on a central region in a radial direction of the core;
an inner blanket fuel region in which blanket fuel assemblies loading another metal fuel are circumferentially arranged on an inner portion of the core fuel region; and
an outer peripheral blanket fuel region in which the blanket fuel assemblies are circumferentially arranged on an outer periphery of the core fuel region, wherein
the metal fuel is formed of a U—Pu—Zr alloy or an alloy of U, Pu, a transuranium (TRU) element other than Pu, and Zr,
the other metal fuel is formed of an alloy of U and Zr, and
the Zr content of the other metal fuel is lower than the Zr content of the metal fuel.

2. The core of a fast reactor according to claim 1, wherein
the inner blanket fuel region is configured to include a first inner blanket fuel region arranged on an inner side in the radial direction of the core and a second inner blanket fuel region arranged on an outer side in the radial direction of the core.

3. The core of a fast reactor according to claim 1, wherein
the Zr content of the metal fuel is 10% by mass, and
the Zr content of the other metal fuel is 6% by mass.

4. The core of a fast reactor according to claim 1, the core further comprising:
control rod assemblies loading a neutron absorption material, wherein
the control rod assemblies are arranged on the inner portion of the core fuel region and are not arranged on the periphery of the inner blanket fuel region.

5. The core of a fast reactor according to claim 1, wherein
the diameter of a fuel element constituting the blanket fuel assembly is larger than the diameter of a fuel element constituting the core fuel assembly.

6. The core of a fast reactor according to claim 5, wherein
the diameter of the fuel element constituting the blanket fuel assembly of the outer peripheral blanket fuel region is larger than the diameter of the fuel element constituting the blanket fuel assembly of the inner blanket fuel region.

7. The core of a fast reactor according to claim 1, wherein
in the core fuel assembly, a upper axial blanket fuel including the other metal fuel is further loaded vertically above the loaded metal fuel in a core axial direction and a lower axial blanket fuel including the other metal fuel is further loaded vertically below the loaded metal fuel in the core axial direction.

8. The core of a fast reactor according to claim 7, wherein
the length of the other metal fuel loaded in the fuel element constituting the blanket fuel assembly in the core axial direction is shorter than the total length of the metal fuel loaded in the fuel element constituting the core fuel assembly and the lower axial blanket fuel in the core axial direction.

9. The core of a fast reactor according to claim 1, the core further comprising:
an axially upper shielding region in which neutron shieldings are arranged vertically above the core fuel region, the inner blanket fuel region, and the outer peripheral blanket fuel region in the core axial direction in a sealed manner;
an axially lower shielding region in which the neutron shieldings are arranged vertically below the core fuel region, the inner blanket fuel region, and the outer peripheral blanket fuel region in the core axial direction in a sealed manner; and
a radial shielding region in which the neutron shieldings are circumferentially arranged on an outer periphery of the outer peripheral blanket fuel region in the radial direction of the core.
